(19) United States
(12) Patent Application Publication
(10) Pub. No.: US 2011/0271117 A1
(43) Pub. Date: Nov. 3, 2011

(54) USER EQUIPMENT (UE), HOME AGENT NODE (HA), METHODS, AND TELECOMMUNICATIONS SYSTEM FOR HOME NETWORK PREFIX (HNP) ASSIGNMENT

(75) Inventor: Zu Qiang, Kirkland (CA)

(73) Assignee: TELEFONAKTIEBOLAGET L M ERICSSON (PUBL), Stockholm (SE)

(21) Appl. No.: 12/911,174

(22) Filed: Oct. 25, 2010

Related U.S. Application Data
(60) Provisional application No. 61/254,785, filed on Oct. 26, 2009.

(51) Int. Cl. H04L 9/32

(52) U.S. Cl. 713/181

(57) ABSTRACT

A User Equipment (UE), Home Agent node (HA), methods, and a telecommunications system are provided for use during negotiation of IP security associations, such as during an Internet Key Exchange (IKE) procedure, between the UE and the HA. The UE sends to the HA an authentication request comprising an indicator relative to a Home Network Prefix (HNP) to be assigned to the UE. Based on the indicator, the HA assigns a new HNP or re-assigns the HNP already assigned, and sends back a response comprising the assigned HNP. If the UE performs a handover to another access network or establishes a simultaneous binding to the other access network, the UE sends its own HNP in the authentication request thus asking the HA to re-assign the same HNP for the new connection being established. If the UE makes an initial access with a network, the indicator may be left blank, asking for the assignment of a new HNP for the UE.

### RELATED APPLICATIONS

The present application is related to, and claims priority from, the U.S. Provisional Patent Application Ser. No. 61/254,785 entitled “Multiple PDN Connections Over Multiple Accesses Using S2C Interface”, filed on Oct. 26, 2009, the disclosure of which is incorporated here by reference.

### TECHNICAL FIELD

The present invention relates to the field of network access for terminals in the context of packet networks.

### BACKGROUND

For a better and easier understanding of the present invention, reference will be made throughout the disclosure to the following acronyms and their associated definitions:

3GPP 3^{rd} Generation Partnership Program

APN Access Point Name

CDMA Code Division Multiple Access

DSMIPv6 Dual Stack Mobile Internet Protocol version 6

EPS Evolved Packet System

EvDO Evolution Data Optimized

GPRS General Packet Radio Service

HA Home Agent

HNP Home Network Prefix

HoA Home Address

IETF Internet Engineering Task Force

IKEv2 Internet Key Exchange version 2

IP Internet Protocol

LTE Long Term Evolution

PDN Packet Data Network

PGW PDN Gateway

RAN Radio Access Network

RFC Request for Comments

S2c Interface point between UE and PDN

TS Technical Specification

UE User Equipment

WilMAX Worldwide Interoperability for Microwave Access

WLAN Wireless Local Area Network

The System Architecture Evolution (SAE) is the core network architecture of the 3GPP's future LTE wireless communication standard. SAE is the evolution of the GPRS Core Network, with some differences including a simplified architecture, the fact that it is based on an all IP Network (AIPN), support for higher throughput and lower latency access networks (e.g. RANs) and for mobility between multiple heterogeneous RANs, including legacy systems as GPRS, but also non-3GPP systems (e.g. WiMAX). The main component of the SAE architecture is the Evolved Packet Core (EPC), also known as the SAE Core. The EPC will serve as equivalent of the GPRS networks (via the Mobility Management Entity, Serving Gateway and PGW subcomponents). In the EPC, the PGW provides connectivity from the UE to external packet data networks by being the point of exit and entry of data traffic for the UE. A UE may have simultaneous connectivity with more than one PGW for accessing multiple PDNs. The PGW also performs policy enforcement, packet filtering for each user, charging support, lawful Interception and packet screening. Finally, another key role of the PGW is to act as the anchor for mobility between 3GPP and non-3GPP technologies such as WiMAX and 3GPP2 (CDMA 1X and EvDO).

In its ongoing evolution, the 3GPP is trying to find a way to introduce enhancements to EPS that would allow a UE to also support multiple PDN connections over multiple accesses using the DSMIPv6-based S2c interface. The S2c reference point is defined by 3GPP. It is a DSMIPv6-based interface which is specified in IETF RFC 3775 and IETF RFC 5555, herein included by reference. The purpose of the DSMIPv6 procedures is to establish, manage and tear down a mobility tunnel between the UE and the HA function. In Mobile Internet Protocol (Mobile IP), an HA comprises a router functionality on a mobile node's home network that maintains information about the device's current location, as identified in its care-of address. The HA uses tunneling mechanisms to forward Internet traffic so that the device's IP address does not have to be changed each time it connects from a different location. The mobility tunnel establishment is always initiated by the UE, while the mobility tunnel tear down can be initiated either by the UE or the network. Communication between the UE and a correspondent node uses a bidirectional mode of operation. A PDN connection is the association between a UE represented by one IPv4 address and/or one IPv6 prefix and a PDN represented by an APN. According to 3GPP specifications, an HA is typically co-located with a PGW, while according to IETF specifications the HA may be a standalone telecommunications node. In the context of the present invention, it is understood that reference will be made interchangeably to an HA, to a PGW, or a PGW/HA, all of which are understood to comprise the HA function.

When the UE first attaches to the EPS over a first access network, it includes in the messages exchanged with the network parameters to indicate relevant connection information, e.g. the APN, which indicates to which external network the UE connects. The APN can further be used in the EPS network to select the proper PGW to handle the UE. It is known that a PGW can provide connectivity to several external networks and that the PGW uses the APN to connect to the correct external network for servicing the UE.

The existing solution in 3GPP release 8 allows the UE to handover from one access network to another with IP preservation, i.e. with preservation of its assigned IP address. However, this solution does not allow the UE to attach to the EPS over more than one access simultaneously, because the above-mentioned network specifications, and therefore the networks running according to those specifications, do not support this function. Once an attach request received over a target access network is accepted, the UE data path is switched from the source access network by the PGW and the PDN connection over the source access is released accordingly.

Furthermore, in the next release of 3GPP, i.e. in Release 10, UE simultaneous attachments should be supported. For instance, a UE can attach to an LTE access and at the same time attach to a WLAN access, and the UE should be allowed to keep the two connections at the same time. However, while the 3GPP did set up this requirement, there is currently no technical support or proposed implementation to sustain its feasibility. According to this new requirement, the UE should become capable of establishing multiple PDN connections, for example, for the following reasons:

For split terminals (i.e. when the 3GPP terminal function and the DSMIPv6 client function are not integrated. Sometimes they can be located in two different boxes wherein the mobile phone function acts as a modem;

For supporting of IP dual stacks (both IPv4 and IPv6 protocol stack) with single stack legacy core networks (IPv4 only network or IPv6 only network);

For multiple PDNs that support multiple accesses for the UEs.

According to the DSMIPv6 protocol specified in the RFC 5555, in order to set up a DSMIPv6 session with the EPS network, a DSMIPv6 client function (co-located in the UE) first sets up a security association with its HA function (typically co-located with the PGW, according to the 3GPP specifications) by using the IKEv2 as specified in IETF RFC 4306, all of which is also included herein by reference. Then, the DSMIPv6 client and the HA exchange Binding Update and Binding Acknowledgement messages for binding establishment and release. The security association is built based on the HA's IP address and the UE's home IP address (HoA). The HoA is auto-configured based on the HNP. When the UE thereafter moves from one access network to another access network, a new binding update message is sent to update the HA with the UE's new care-of-address.

In 3GPP, the network assigns to the UE one HNP per PDN connection. At mobility, i.e. when the UE moves from one network to another, IP preservation is supported based on the UE's HNP as well. With the DSMIPv6 based network interface, the HNP is assigned during IKEv2 procedure.

There is at least one significant mobility problem, for example when the UE initiates a PDN connection using DSMIPv6 over a new access network, if the UE desires to keep its existing PDN connection over the old access network simultaneously. In such circumstances, if the UE has one or more PDN connections over the home link, and the UE initiates IKEv2 over a new access, the UE may:

want to initiate a new PDN connection with a new HNP over the new access and keep the existing PDN connection(s) with the existing HNP over the old access simultaneously; or

want to handover one of the existing PDN connections from the old access to the new access; or

want to setup a simultaneous (concurrent) PDN connection over the new access with the existing HNP received over the home link that is shared between the PDN connections However, with the implementation of the current IKEv2 protocol, the EPS network (i.e. more particularly the HA function of the PGW) is not able to know what type of request should be supported for the UE and which HNP should be assigned to the UE.

Although it stops short of suggesting the teachings of the present invention, the US patent publication 2009/0144809 bears some relation with the field of the present invention. This patent publication teaches a home network prefix used to assign a home address to a mobile node. Authentication by use of tokens ensures that connections are legitimate. All sessions are connected through a foreign agent. However, this publication stops short of teaching or suggesting a solution as proposed by the present invention.

### SUMMARY

In one aspect, the present invention provides a method for assigning a Home Network Prefix (HNP) to a User Equipment (UE), during a procedure for negotiating an IP security association between the UE and a Home Agent node (HA), such as during an IKE procedure. First, the method allows for receiving from the UE at an HA node an authentication request message comprising an indicator as to the Home Network Prefix (HNP) to be assigned to the UE, and based on the indicator, selectively assigning a new HNP to the UE or an HNP already assigned to the UE, and sending an authentication response message to the UE comprising one of the new HNP and the HNP already assigned to the UE.

In another aspect, the present invention provides a method for assigning an HNP to a UE during a procedure for negotiating an IP security association between the UE and an HA Node, such as during an IKE procedure. The method allows for sending from the UE to the HA Node an authentication request message comprising an indicator as to the HNP to be assigned to the UE; and responsive thereto, receiving at the UE an authentication response message comprising one of a new HNP and an HNP already assigned to the UE.

In yet another aspect, the present invention provides an HA comprising a communication interface that receives from a UE, during the procedure for negotiating an IP security association between the UE and the HA, an authentication request message comprising an indicator as to a HNP to be assigned to the UE; a processor; and an instructions repository operationally connected to the processor, that stores instructions that when executed by the processor, cause the processor to selectively assign to the UE, based on the indicator, a new HNP to the UE or an HNP already assigned to the UE, and further cause the processor to send, via the communication interface an authentication response message to the UE comprising one of the new HNP and the HNP already assigned to the UE

In yet another aspect, the present invention provides a UE comprising a communication interface; a processor; and an instruction repository operationally connected to the processor, that stores instructions that when executed by the processor cause the processor to send via the communication interface, during a procedure for negotiating an IP security association between the UE and a HA, an authentication request message comprising an indicator as to the HNP to be assigned to the UE, wherein the communication interface receives, in response to the authentication Request message sent, an authentication response message comprising one of a new HNP and an HNP already assigned to the UE.

In yet another aspect, the present invention provides a telecommunications system, comprising a UE, that during a procedure for negotiating an IP security association between the UE and an HA (e.g. an IKE procedure), sends out to the HA an authentication request message comprising an indicator as to the HNP to be assigned to the UE. The telecommunications system further comprises an HA receiving the authentication request message from the UE, and based on the indicator, selectively assigning a new HNP to the UE or an HNP already assigned to the UE, and sending out to the UE an authentication response message to the UE comprising one of the new HNP and the HNP already assigned to the UE.

### DRAWINGS

For a more detailed understanding of the invention, for further objects and advantages thereof, reference can now be made to the following description, taken in conjunction with the accompanying drawings, in which:

FIG. 1 is an exemplary nodal operation and signal flow diagram of a network implementing the preferred embodiment of the present invention;

FIG. 2 is an exemplary high-level network diagram of a network implementing an aspect of the preferred embodiment of the invention;

FIG. 3 is an exemplary flowchart diagram of a method according to the preferred embodiment of the invention;

FIG. 4 is an exemplary node diagram of a UE implementing the preferred embodiment of the invention;

FIG. 5 is another exemplary node diagram of a PGW/HA implementing the preferred embodiment of the invention; and

FIGS. 6a through 6d are exemplary representations of the indicator according to the preferred embodiments of the invention.

### DETAILED DESCRIPTION

With the current implementation of the IKEv2 protocol, the EPS network (i.e. particularly the HA function, e.g. of the PGW) is not able to know what type of request a UE makes towards the network, and for this reason cannot determine which HNP should be assigned to the UE. For example, the UE can make several types of requests: an initial attachment request when attaching to the network for an initial connection, a hand-over request to a different access network, or a simultaneous binding type of attach request when requesting an additional connection over a different access network. One of the reasons for this problem is that, in IETF specifications, the DSMIPv6 mobility is based on the UE's HoA, the HoA itself being based on an HNP value shared by multiple users. In its current version, the IKEv2 protocol does not support any mobility related parameters, or any type of attribute or indicator that could indicate to the network the attachment request type of the UE. In so doing, the current IKEv2 protocol fails to provide to the network any hint or information regarding the type of HNP to be assigned to the UE. While in IETF the UE's mobility is based on the UE's HoA, in 3GPP, the mobility is based on the UE's HNP, which is unique for each PDN connection. According to 3GPP specifications, when a UE is handed over from one access to a new access, the UE should setup a new PDN connection. The network should assign the same HNP to the new PDN connection in order to support session connectivity. For that purpose, according to current 3GPP specifications, the IKEv2 function should return the current HNP. However, there is currently no known implementation that can provide such a result.

In 3GPP specifications, an HA is typically co-located with a PDN gateway, while according to IETF specifications the HA may be a standalone telecommunications node. In the context of the present invention, it is understood that reference will be made interchangeably to an HA, to a PGW, or a PGW/HA, all of which are understood to comprise the HA function. The following description and claims will also refer to an HA node, as a node that comprises an HA function and that may take the form of any one of the above described implementations, including an IETF-based HA and a 3GPP-based PGW/HA.

The present invention alleviates at least the above-mentioned shortcomings. In one aspect, the present invention provides for an indicator to be supported over IKEv2 protocol, in order to specify to the network's HA node the type of access being requested by the UE, so that the HA node, being informed of the access type of a given UE, can select the proper HNP to be assigned to the requesting UE. Accordingly, the invention introduces a mechanism to enhance the IKEv2 protocol with the provision of the aforementioned indicator that allows the HA to know what HNP should be assigned to the UE, in order to provide, for example, for proper support of simultaneous multiple connections over multiple accesses simultaneously and for hand-off from one connection to another.

In one aspect, the present invention adds a request type indicator for each PDN connection requested at the time of IKEv2 procedure to specify whether the same HNP should be reused, or if a new HNP should be assigned to the UE. The request type indicator is selectively sent by the UE as a payload of the IKE_AUTH request message to indicate that the UE would like to receive a new HNP (e.g. for a new PDN connection), or an existing HNP (e.g. for a handover), or—again—an existing HNP (e.g. for simultaneous binding i.e. a new binding over another access network while keeping the existing connection).

The present invention may be implemented using the EPC's architecture specified for IETF based protocols in 3GPP TS 23.402, for example. The S2c interface is specified in 3GPP TS 24.303, all of which are herein included by reference.

In one aspect of the present invention, the indicator is, or comprises, an HNP, or an HNP attribute. The HNP attribute is an IKEv2 attribute used to carry HNP information. The UE may selectively send the HNP attribute which contains the assigned HNP from a previous or current attachment. This HNP attribute can be used by the network as an HNP assignment hint in the IKEv2 procedure. When the HA node receives the HNP attribute via the IKE_AUTH message, if it contains a valid HNP assigned to the UE over the home link, the HA understands that the UE would like to keep the same HNP for e.g. a handover or a simultaneous binding. Then, the network assigns the requested HNP to the UE using the IKEv2 response message. If a zero length, or a blank HNP attribute field is received instead, the HA alternatively understands that the UE would like to initiate a new PDN connection over the S2c interface, which triggers the network to assign a new HNP to the UE in the IKEv2 response message.

In another aspect, the present invention defines a request type indicator that may take any type of form as preferred by any given network implementation. One example may be an indicator with a value “0” to inform that the UE's request is an initial attachment, with a value of “1” to inform the network that the UE's request is for a handover-type of attachment, or with a value of “2” to inform the network that the UE's request is for a simultaneous binding. When the indicator contains a non-zero value, an HNP may also be attached, providing the HNP that the UE would like to be (re)-assigned. The format of this indicator may be compatible with an attribute format from RFC 4306, which is herein included by reference. If the HA node supports, i.e. understands the meaning of the received attribute, it assigns a new HNP, or an existing HNP, or rejects the request based on the UE requirement and network policy.

The present invention makes it possible, for example, for an LTE UE to indicate a simultaneous multiple connections request over multiple accesses by using the DSMIPv6 protocol, or indicate a handover request of one or multiple specified connections or media IP flows from one access network to another, and is also compatible with the DSMIPv6 protocol as currently defined.

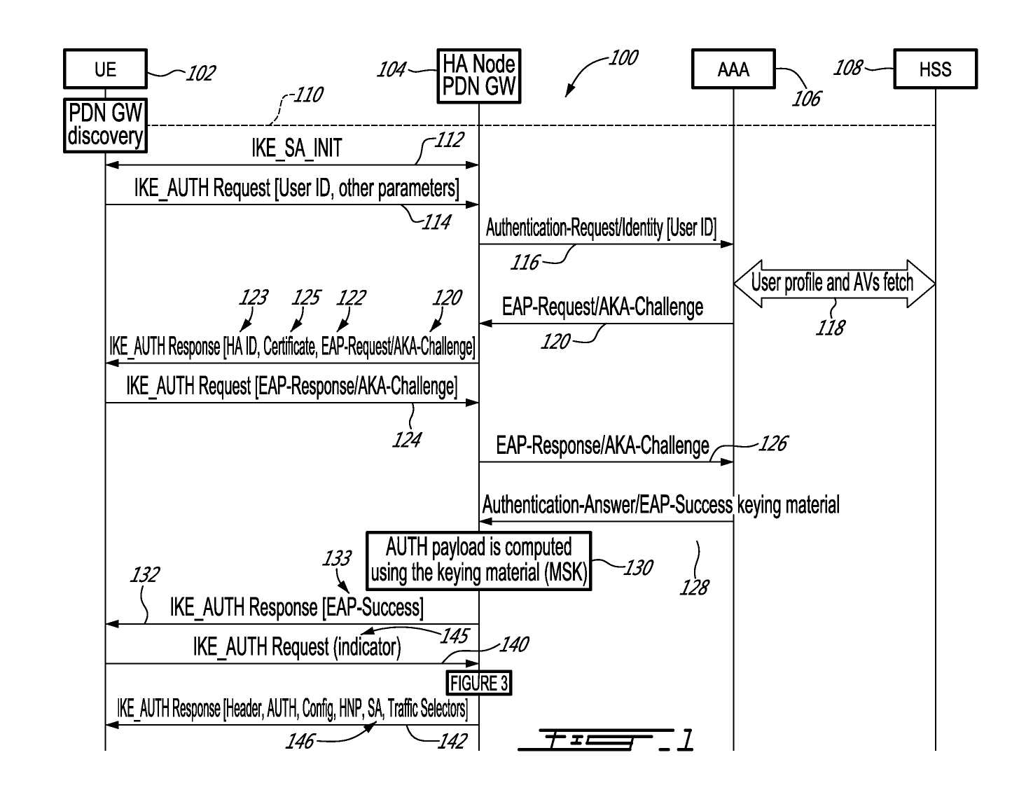

Reference is now made to FIG. 1, which is an exemplary nodal operation and signal flow diagram of a network 100 implementing the preferred embodiment of the present invention. FIG. 1 shows the bootstrapping procedure performed by the UE including the discovery of the HA node address, which in case of EPS is the IP address of the PGW. As soon as the UE discovers the PGW address, it establishes an IPsec Security Association with the Home Agent through IKEv2. The IKEv2 UE to Home Agent authentication is performed using Extensible Authentication Protocol (EAP). According to the invention, when the UE runs IKEv2 with its HA node, it requests an IPv6 HNP through the exchange of the request type indicator in the IKE_AUTH exchange by selectively including an HNP attribute. For example, the IPv6 HNP may be included in an HNP attribute called PDN Identifier notify payload that is exchanged during the IKEv2 procedure in a manner that will be described herein. When the HA node receives and processes the message, it allocates an HNP based on the indicator received, and sends the allocated HNP back to the UE. The UE then auto-configures a HoA based on the IPv6 HNP received from the HA node.

The IPv6 HNP allocation through IKEv2 allows binding the Home Address with the IPsec security association so that the UE can only send Binding Updates for its own Home Address and not for other UEs' Home Addresses.

With reference being now specifically made to FIG. 1, first, in action 110 UE 102 discovers the address of the PDN GW 104 based on known procedures, such as for example the one specified in 3GPP's TS 23.402.

In action 112, the UE 102 start the IKEv2 procedure with the PGW 104 by carrying out an IKE_SA_INIT exchange. In this phase the PGW 104 and UE 102 negotiate cryptographic algorithms, exchange security information and perform a Diffie-Hellman exchange for generating the required security key to be used in order to secure communications there between.

In action 114, the UE 102 sends the user identity and other parameters including the APN identifier in this first message of the IKE_AUTH phase, and begins negotiation of child security associations.

In action 116, the PDN GW 104 sends an Authentication Request message to the 3GPP AAA Server 106, containing the user identity, APN and a parameter indicating that the authentication is being performed for DS-MIPv6 security (not shown).

In action 118, the 3GPP AAA Server 106 fetches the user profile and Authentication Vector (AVs) from HSS/HLR 108 (if these parameters are not available in the 3GPP MA Server). The 3GPP AAA Server 106 includes the parameter received in action 116 indicating that the authentication is being performed for DSMIPv6 in the request to the HSS 108. The HSS then generates AVs and sends them back to the 3GPP AAA server 106, which checks that the UE is authorised to use the APN.

In action 120, based on the identity received, the 3GPP MA server 106 selects an AV (e.g. RAND, AUTN, CK, IK, XRES) for the UE 102. The 3GPP AAA Server 106 then initiates the authentication challenge by sending the EAP-Request/AKA-Challenge message containing RAND and AUTN as described by RFC 4187. The user identity is not requested again, as in a normal authentication process, because there is the certainty that the user identity received in the EAP Identity Response message has not been modified or replaced by any intermediate node. The reason is that the user identity was received via an IKEv2 secure channel which can only be decrypted and authenticated by the end points (the PGW 104 and the UE 102).

In action 122, the PGW 104 responds to the UE 102 with its identity 123, a certificate 125, and sends the AUTH parameter 120 to protect the previous message it sent to the UE (in the IKE_SA_INIT exchange). The EAP message received from the 3GPP AAA Server 106 (EAP-Request/AKA-Challenge), which contains RAND and AUTN, is included in order to start the EAP procedure over IKEv2.

In action 124, the UE 102 checks whether the AUTN is correct and, if so, responds back to the authentication challenge.

In action, 126, the PGW 104 forwards the EAP-Response/AKA-Challenge message to the 3GPP AAA Server 106, and in action 128, the 3GPP AM Server 106 checks the EAP message and returns an Authentication Answer including an EAP success and the key material to the PGW 104. This key material includes the MSK generated during the authentication process. In case of PGW reallocation upon attach on S2c, the AAA shall include the target PGW's identity as specified in 3GPP TS 23.402. The 3GPP AAA Server 106 also updates accordingly the information of IKE Security Associations active for the APN.

In action 130, the AUTH payload is computed using the received MSK and in action 132, the EAP Success message 133 is forwarded to the UE over IKEv2.

In action 140, the UE 102 generates MSK as input to generate an AUTH parameter to authenticate the first IKE_SA_INIT message. According to the invention, in the same action 140, the UE sends via the IKE_AUTH Request message the Indicator 145 that specifies to the PGW 104 which HNP to be assigned to the UE 102. The following cases are possible:

| | Indicator | | |
|---|---|---|---|
| | exemplary | | |
| | content: | PDN/HA | Applications |
| UE sends | i) MIPv6 | Understands | handover to |
| IKE_AUTH_Request | HNP, and | UE wants | another access |
| comprising | | same HNP | network, and re- |
| indicator 145 | | and assigns | attachment with |
| | | same HNP | same HNP |
| | | | keep all bindings |
| | | | over multiple access |
| | | | network with same |
| | | | HNP |
| | BLANK | Understands | i. initial network |
| | | UE wants | attachment |
| | | new HNP | |
| | | and allocates | |
| | | new HNP | |

Upon receipt of the message 140, the PDN GW 104 checks the correctness of the AUTH received from the UE 102 and calculates the AUTH parameter which authenticates the second IKE_SA_INIT message (actions not shown).

Reference is now made jointly to FIG. 1, previously described, and to FIG. 3, which is a flowchart diagram of an exemplary method performed by the HA node 104 upon receipt of the AUTH_REQUEST message 140 from the UE 102, according one of the preferred embodiment of the invention. In action 302, the HA node 104 receives the message 140, and in action 304 the HA node determines if the indicator 145 is found. If not, the method assigns (e.g., by default) in action 314 a new HNP 146 to the UE 102, and in action 320 sends to the UE 102 the HNP 146 so-assigned via the IKE_AUTH Response message 142. If in action 304, the HA node 104 rather determines that the indicator 145 is present in the message 140, it then checks the validity of the indicator, action 306, and if any error case occurs, such as for example if the indicator cannot be fully read or is otherwise improper, then the method moves to action 314 where a new HNP is assigned for the UE 102, and sent to the UE 102 in action 320. If in action 306 the determination is that the indicator is valid, then the method moves on to action 308 and searches for the active corresponding PDN connection(s). For example, in action 306 the method may extract the HNP from the message 140, and use the received HNP to find the associated PDN connection in action 308. If a connection is not found, in action 310 the method moves again to action 314 and assigns and sends to the UE a new HNP. Otherwise, if a PDN connection is found, it is determined in action 310 that the HA node 104 should assign to the UE 102 the existing HNP, action 312, then move to action 320 where the assigned HNP 146 is sent out to the UE 102 via the IKE AUTH Response message 142.

Returning to FIG. 1, in action 142, the PGW 104 sends the assigned HNP 146 via the IKEv2 Authentication Response message using, for example, an MIPv6_Home_Prefix attribute that carries the HNP. The AUTH parameter is also sent to the UE 102 together with the configuration payload, security associations and the rest of the IKEv2 parameters and the IKEv2 negotiation terminates.

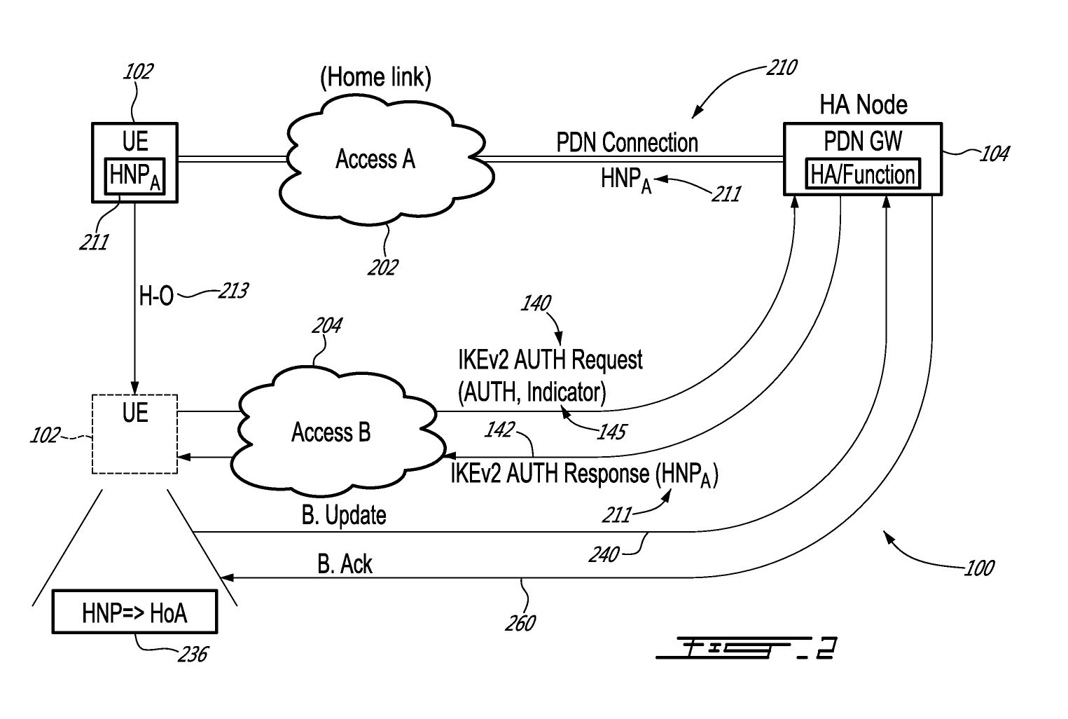

Reference is now being made to FIG. 2, which is an exemplary high-level network diagram of a network implementing an aspect of the preferred embodiment of the invention. FIG. 2 shows an exemplary scenario when the UE 102 performs a handover 213 from a first access network 202 to another access network 204 when an initial PDN connection 210 is already established, and where the UE 102 has already been assigned a first HNPA 211. When the UE 102 accesses the 2nd access network 204 during the handover procedure 213, it establishes the security association and obtains the IPv6 HNP 211 as per the procedure shown in FIG. 1 (of which only actions 140-142 are shown in FIG. 2 for simplicity). For example, in actions 140 and 142 the UE 102 exchanges the AUTH_Request and the AUTH_Response messages with the HA node 104 via the target access network 204, wherein the UE 102 signals to the network, via the indicator 145, that it wants to be re-assigned the same HNP for the ne connection being established with the PGW 104 via the 2^{nd} access network 204. In action 142, the UE 102 is provided with the same HNP 211 via the message 142. Then, the UE 102 constructs a home address (HoA) from the received HNP 211 as specified in RFC2460. The HoA is used as the identity of the Binding Update/Ack message exchanged with the HA node 104. Then the UE 102 sends a Binding Update message 240 as specified in IETF RFC 3775 and IETF RFC 5555 in order to register its Home Address and Care-of Address at the HA node 104. When receiving the BU message 240, the HA node establishes a binding with the CoA for the UE 102, and responds with a Binding Acknowledgement message 260 to UE 102 and starts forwarding any downlink payload packets to the CoA address. Once the Binding Acknowledgement message 260 is received, the UE 102 can start sending uplink payload packets by using the DSMIP tunnel.

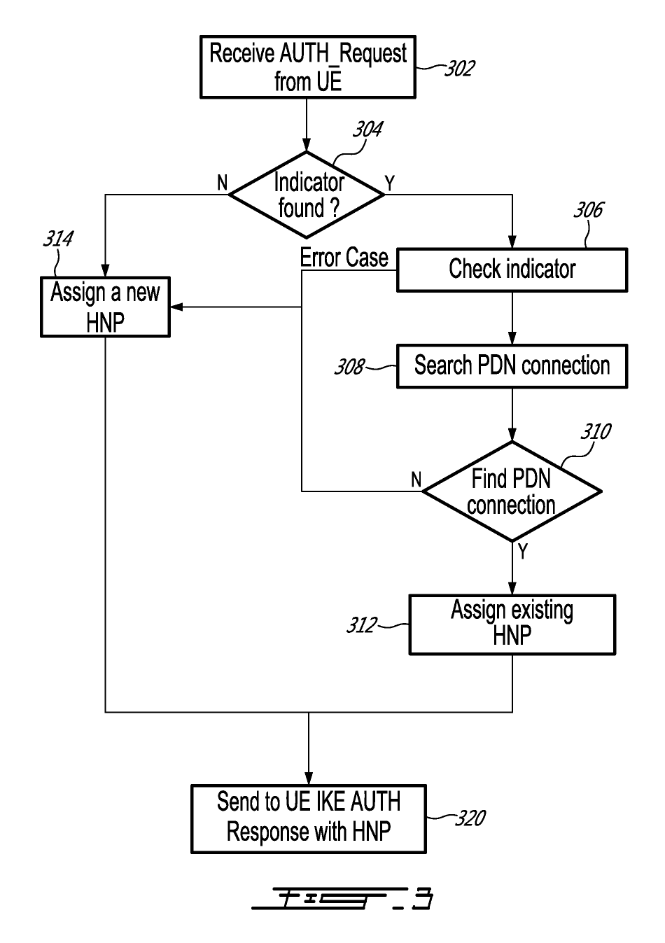

Reference is now further being made to FIG. 4, which is an exemplary node diagram of an exemplary UE 102 implementing the preferred embodiment of the invention. The UE 102 comprises a communication Input/Output (I/O) interface 404 for communicating with the network 100. Such a communication interface may include, for example, a radio interface that allows the UE 102 to exchange signaling and data with the network 100, via access networks alike the access networks 202-204, as it is known in the art. The UE 102 may further comprise a processor 402 and an instructions repository 406 which includes instructions that when executed cause the processor to perform the actions associated with the UE 102 as previously described in relation to FIGS. 1 and 2. The processor 402 may be any type of processor or processing module, including but being not limited to a computer processor, an ASIC (application-specific integrated circuit) module, a programmed chipset, or the like. Likewise, the instructions repository 506 may include an application, a script, or any other type of instructions that can cause the processor to perform and issue, alone or in combination with other modules, e.g. the communication interface 404, the actions and messages shown in relation to FIGS. 1 and 2. For example, the instructions repository may include an IKE protocol stack supporting IKE-based communications that execute on the processor 402 and cause the later to send via the communication interface 404 the messages shown in FIG. 1 that originate at the UE 102, and further cause the processor to process the messages received by the UE 102, as described hereinbefore.

FIG. 5 is another exemplary node diagram of an HA Node 104 implementing the preferred embodiment of the invention. The PGW/HA 104 comprises a communication interface 504 for communicating with the network 100, including the UE 102. The HA Node 104 may further comprise a processor 502 and an instructions repository 506 which includes instructions that when executed cause the processor 502 to perform the actions associated with the HA Node 104 as previously described in relation to FIGS. 1 and 2. The processor 502 may be any type of processor or processing module, including but being not limited to a computer processor, an ASIC (application-specific integrated circuit) module, a programmed chipset, or the like. Likewise, the instructions repository 506 may include an application, a script, or any other type of instructions that can cause the processor 502 to perform and issue, alone or in combination with other modules, e.g. the communication interface 404, the actions and messages shown in relation to FIGS. 1 and 2. For example, the instructions repository may include an IKE protocol stack supporting IKE-based communications that execute on the processor 502 and cause the later to process and/or send, e.g. via the communication interface 504, the messages shown in FIG. 1 that involve the HA Node 104.

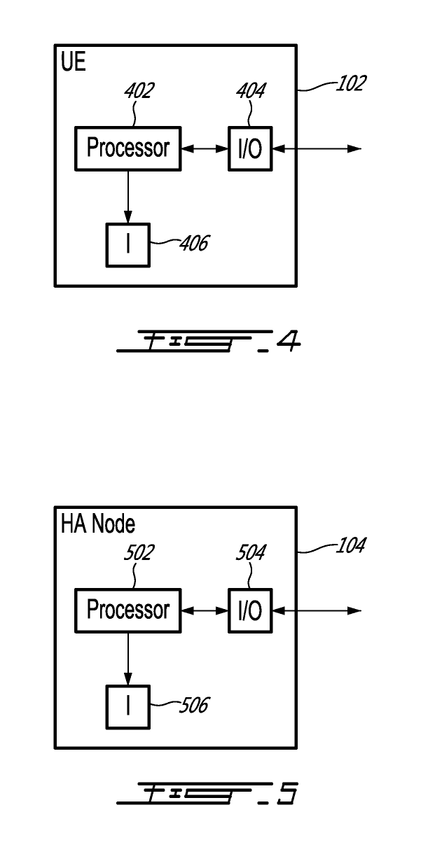

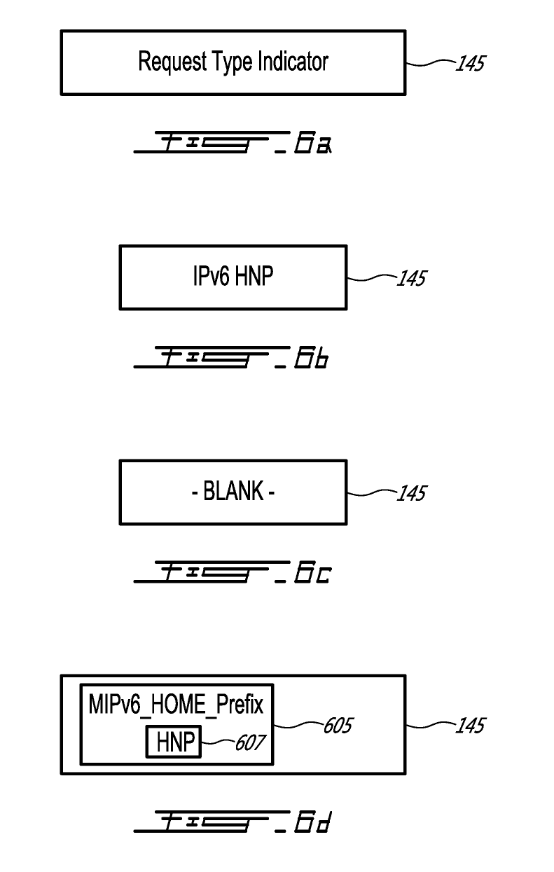

Reference is now being made to FIGS. 6a through 6e that show exemplary representation of the indicator 145 according to the preferred embodiments of the present invention. As previously presented, the indicator 145 may be part of the IKE_AUTH_REQUEST message 140 sent from the UE 102 to the HA node 105. In FIG. 6a, the indicator 145 is shown in a generic format. The indicator 145 may take whatever appropriate form according to a preferred network implementation and operator's preferences, provided it indicates to the HA if a new HNP is to be assigned to the UE or if the same HNP is to be reassigned, as presented hereinbefore. FIG. 6.b shows an exemplary indicator 145 that takes the form of the MIPv6 HNP assigned to the UE. According to this variant, the UE inserts its own HNP as the indicator if it desires to re-use the same HNP. Alternatively, the UE leaves the indicator blank, as shown in FIG. 6.c if it desires to be assigned a new HNP. Finally, FIG. 6.d shows the indicator 145 in a preferred implementation wherein the MIPv6_Home_Prefix attribute 605 of the IKE_AUTH_Response message 140 is used to carry the UE 102 would like to be assigned by the HA node 104. As described hereinbefore, the MIPv6_Home_Prefix 605 may actually carry the requested HNP 605, or alternatively be left blank in case the suggestion is for a new HNP to be assigned to the UE 102. Those skilled in the art will understand that the illustrations of FIGS. 6a-6d are exemplary only, and that other implementations may be contemplated within the scope of the invention for notifying the HA of the desired HNP to be assigned to the UE.

Based upon the foregoing, it should now be apparent to those of ordinary skills in the art that the present invention provides an advantageous solution, which offers a simple yet flexible and efficient manner for assigning the proper HNP to a UE. Although the system and method of the present invention have been described with particular reference to certain type of messages and nodes, it should be realized upon reference hereto that the innovative teachings contained herein are not necessarily limited thereto and may be implemented advantageously in various manners. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for assigning a Home Network Prefix (HNP) to a User Equipment (UE), the method comprising the steps of:
a) during an Internet Key Exchange (IKE) procedure between the UE and a Home Agent node (HA), receiving from the UE an authentication request message comprising an indicator relative to a Home Network Prefix (HNP) to be assigned to the UE;
b) based on the indicator, assigning to the UE one of a new HNP and an HNP already assigned to the UE; and
c) sending a response message to the UE comprising one of the new HNP and the HNP already assigned to the UE.

2. The method of claim 1, wherein the IKE procedure is performed using an IKEv2 protocol, the authentication request message comprises an IKE Authentication Request message, the response message comprises an IKE Authentication Response message, and the indicator comprises a Home Network Prefix attribute.

3. The method claimed in claim 2, wherein the authentication request message comprises the HNP already assigned to the UE, and wherein in step b) the HNP already assigned to the UE is re-assigned to the UE, and the authentication response message comprises the HNP already assigned to the UE.

4. The method claimed in claim 2, wherein the authentication request message comprises a blank Home Network Prefix attribute, and wherein in step b) a new HNP is assigned to the UE, and the authentication response message comprises the new HNP assigned to the UE.

5. The method claimed in claim 1, wherein the steps a) to c) are performed in the HA, and wherein the HA is co-located with a 3GPP-based Packet Data Network (PDN) Gateway.

6. The method of claim 1, wherein steps a) to c) are performed in the HA, wherein step b) further comprises the steps of:
b.1) checking if the indicator is found in the authentication request message;
b.2) if the indicator is not found, assigning a new HNP to the UE; and
b.3) if the indicator is found, checking the indicator comprises a valid HNP, determining a PDN connection for which the security association is being set up, and re-assigning to the UE the HNP already assigned.

7. A method for assigning a Home Network prefix (HNP) to a User Equipment (UE), the method comprising the steps of:
a) during an Internet Key Exchange (IKE) procedure between the UE and a Home Agent node (HA), sending from the UE an authentication request message comprising an indicator relative to a Home Network Prefix (HNP) to be assigned to the UE; and
b) responsive to step a), receiving at the UE a response message comprising one of a new HNP and an HNP already assigned to the UE.

8. The method of claim 7, wherein the IKE procedure between the UE and the HA is performed using an IKEv2 protocol, the authentication request message comprises an IKE Authentication Request message, the response message comprises an IKE Authentication Response message, and the indicator comprises an HNP.

9. The method claimed in claim 8, wherein the authentication request message comprises the HNP already assigned to the UE, and wherein in step b) the HNP already assigned to the UE is sent the UE via the authentication response message.

10. The method claimed in claim 8, wherein the authentication request message comprises a blank HNP attribute, and wherein in step b) a new HNP is sent to the UE via the authentication response message.

11. The method claimed in claim 7 further comprising the steps of:
c) using an HNP received in step b) to create a Home Address (HoA) by the UE;
d) accessing a second access network by the UE, and using the HoA to send to the HA via the second access network a Binding Update message; and
e) responsive to step d), receiving a Binding Acknowledgement message that confirms a security binding of the UE with the HA via the second access network.

12. A Home Agent node (HA), comprising:
a communication interface configured to receive from a UE, during an Internet Key Exchange (IKE) procedure between the UE and the Home Agent (HA), an authentication request message comprising an indicator relative to a Home Network Prefix (HNP) to be assigned to the UE;
a processor;
an instructions repository operationally connected to the processor, that stores instructions that when executed by the processor, cause the processor to assign to the UE, based on the indicator, one of a new HNP and an HNP already assigned to the UE, and further cause the processor to send, via the communication interface a response message to the UE comprising one of the new HNP and the HNP already assigned to the UE.

13. The HA of claim 12, wherein the IKE procedure between the UE and the HA is performed using an IKEv2 protocol, the authentication request message comprises an IKE Authentication Request message, the response message comprises an IKE Authentication Response message, the indicator comprises an HNP attribute.

14. The HA of claim 13, wherein the authentication request message comprises an HNP already assigned to the UE, and wherein the HNP already assigned to the UE is re-assigned to the UE, and the authentication response message comprises the HNP already assigned to the UE.

15. The HA of claim 13, wherein the authentication request message comprises a blank Home Network Prefix attribute, and wherein the new HNP is assigned to the UE, and the authentication response message comprises the new HNP assigned to the UE.

16. The HA of claim 12, wherein when assigning the HNP, the processor checks if the indicator is found in the authentication request message, and if the indicator is not found, assigns a new HNP to the UE, while if the indicator is found, the processor further checks the indicator comprises a valid HNP, determines the PDN connection for which the security association is being set up, and re-assigns to the UE the HNP already assigned.

17. The HA of claim 12, wherein the HA is co-located with a 3GPP-based Packet Data Network (PDN) Gateway.

18. A User Equipment (UE) comprising:
a communication interface;
a processor;
an instruction repository operationally connected to the processor, that stores instructions that when executed by the processor cause the processor to send via the communication interface, during an Internet Key Exchange (IKE) procedure between the UE and a Home Agent node (HA), an authentication request message comprising an indicator relative to a Home Network Prefix (HNP) to be assigned to the UE;
wherein the communication interface receives, in response to the authentication Request message sent, a response message comprising one of a new HNP and an HNP already assigned to the UE.

19. The UE of claim 18, wherein the IKE procedure between the UE and the HA is performed using an IKEv2 protocol, the authentication request message comprises an IKEv2 Authentication Request message, the authentication response message comprises an IKEv2 Authentication Response message, and the indicator comprises an HNP attribute.

20. The UE claimed in claim 19, wherein the authentication request message comprises the HNP already assigned to the UE, and wherein the HNP already assigned to the UE is received via the authentication response message.

21. The UE claimed in claim 19, wherein the authentication request message comprises a blank Home Network Prefix attribute, and wherein the new HNP is received via the authentication response message.

22. The UE claimed in claim 18 wherein the instructions repository further comprises instructions that when executed further cause the processor to use the HNP received in the Authentication Response message to create a Home Address (HoA), and during an access via a second access network, to use the HoA to send to the HA, via the communication interface, a Binding Update message, wherein the communication interface receives, responsive to the sent Binding Update message a Binding Acknowledgement message that confirms a binding of the UE with the HA via the second access network.

23. A telecommunications system, comprising:
a User Equipment (UE), that during an Internet Key Exchange (IKE) procedure between the UE and a Home Agent (HA), sends out to the HA an authentication request message comprising an indicator relative to an Home Network Prefix (HNP) to be assigned to the UE; and
an Home Agent node (HA) receiving the authentication request message from the UE, and based on the indicator, assigning to the UE one of a new HNP or an HNP already assigned to the UE, and sending out to the UE a response message comprising one of the new HNP and the HNP already assigned to the UE.

24. The telecommunications system of claim 23, wherein the IKE procedure between the UE and the HA is performed using an IKEv2 protocol, the authentication request message comprises an IKE Authentication Request message, the response message comprises an IKE Authentication Response message, the indicator comprises an HNP attribute.

25. The telecommunications system claimed in claim 24, wherein the authentication request message comprises the HNP already assigned to the UE, and wherein in step b) the HNP already assigned to the UE is re-assigned to the UE, and the authentication response message comprises the HNP already assigned to the UE.

26. The telecommunications system claimed in claim 24, wherein the authentication request message comprises a blank Home Network Prefix attribute, and wherein in step b) a new HNP is assigned to the UE, and the authentication response message comprises the new HNP assigned to the UE.
